(19) United States
(12) Patent Application Publication
(10) Pub. No.: US 2007/0199057 A1
(43) Pub. Date: Aug. 23, 2007

(54) CONTROL OF APPLICATION ACCESS TO SYSTEM RESOURCES

(75) Inventor: David W. Plummer, Redmond, WA (US)

Correspondence Address: BLACK LOWE & GRAHAM, PLLC, 701 FIFTH AVENUE, SUITE 4800, SEATTLE, WA, 98104, US

(73) Assignee: SoftwareOnline, LLC, Redmond, WA (US)

(21) Appl. No.: 11/549,783

(22) Filed: Oct. 16, 2006

Related U.S. Application Data
(60) Provisional application No. 60/727,288, filed on Oct. 14, 2005.
(60) Provisional application No. 60/805,683, filed on Jun. 23, 2006.

(51) Int. Cl. H04L 9/32

(52) U.S. Cl. 726/9

(57) ABSTRACT

A method of controlling the access by an application to system resources includes accessing data related to access by the application to at least one of the system resources. A request to run the application is received. A first access token is created and has a first set of attributes that enable access to at least one of the system resources and that are selected based on the data. The first token is based on a second access token having a second set of the attributes. The first-set attributes are fewer in number than the second-set attributes. The first token is then associated with the application.

### PRIORITY CLAIM

The present application claims priority from U.S. Provisional Application No. 60/727,288 filed Oct. 14, 2005, and U.S. Provisional Application No. 60/805,683 filed on Jun. 23, 2006, which are, along with commonly owned and co-pending U.S. application Ser. No. 11/351,257 filed on Feb. 6, 2006, herein incorporated by reference.

### FIELD OF THE INVENTION

Embodiments of the invention relate generally to computer systems and, more particularly, to improvements in security for computer systems.

### BACKGROUND OF THE INVENTION

In computing, if a task is performed by a user having more privileges than necessary to do that task, there is an increased risk that the user will inadvertently (or perhaps intentionally) do harm to computer resources. By way of example, if a set of files can only be deleted by a user with administrator privileges, then an administrator may inadvertently delete those files when performing another task that does not need to be accomplished by an administrator. If the administrator had been a user having lesser privileges, then the intended task could still have been performed but the inadvertent deletion would not have been allowed.

As such, a goal in computer security is the concept of least privilege in which a user performing a task should run with the absolute minimum privileges (or identities, such as group memberships) necessary to perform that task. In at least one operating system, when the user logs on, an access token is built for the user corresponding to the user's credentials. The access token determines the access rights and privileges that the user will have for that session and, perhaps, future sessions. While ideally an administrator can set up multiple identities and log-on as a different user with different rights for each task, this may be too burdensome and too complicated.

### SUMMARY OF THE INVENTION

In an embodiment of the invention, a method of controlling the access by an application to system resources includes accessing data related to access by the application to at least one of the system resources. A request to run the application is received. A first access token is created and has a first set of attributes that enable access to at least one of the system resources and that are selected based on the data. The first token is based on a second access token having a second set of the attributes. The first-set attributes are fewer in number than the second-set attributes. The first token is then associated with the application.

### BRIEF DESCRIPTION OF THE DRAWINGS

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a block diagram generally representing the creation of a limited token from an existing token according to an embodiment of the invention; and

FIGS. 4-8 are flow diagrams illustrating methods according to embodiments of the invention.

### DETAILED DESCRIPTION OF THE PREFERRED EMBODIMENT

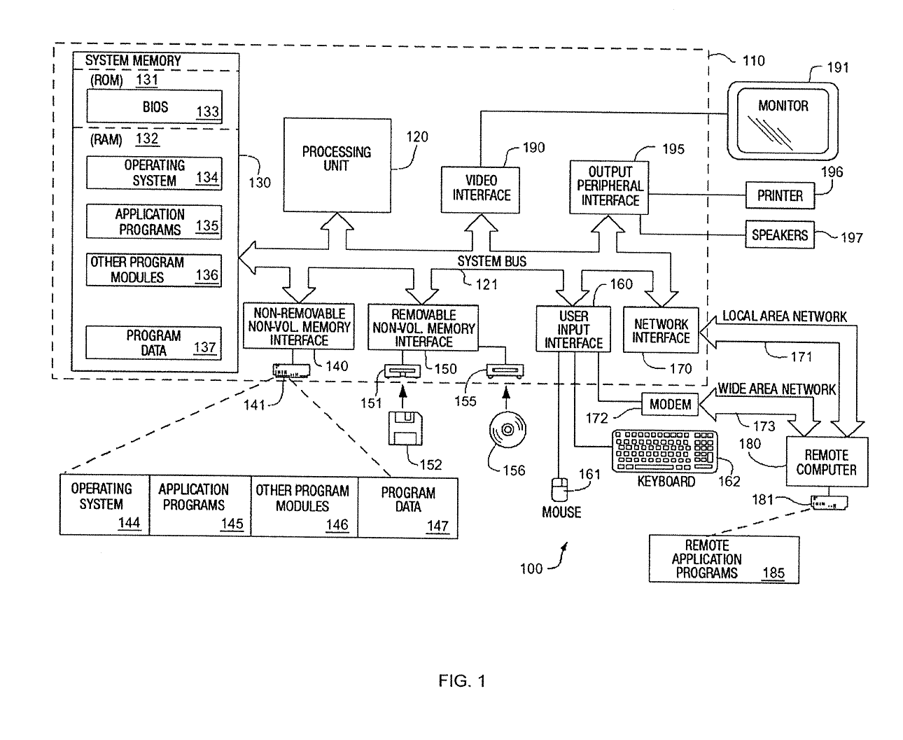

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

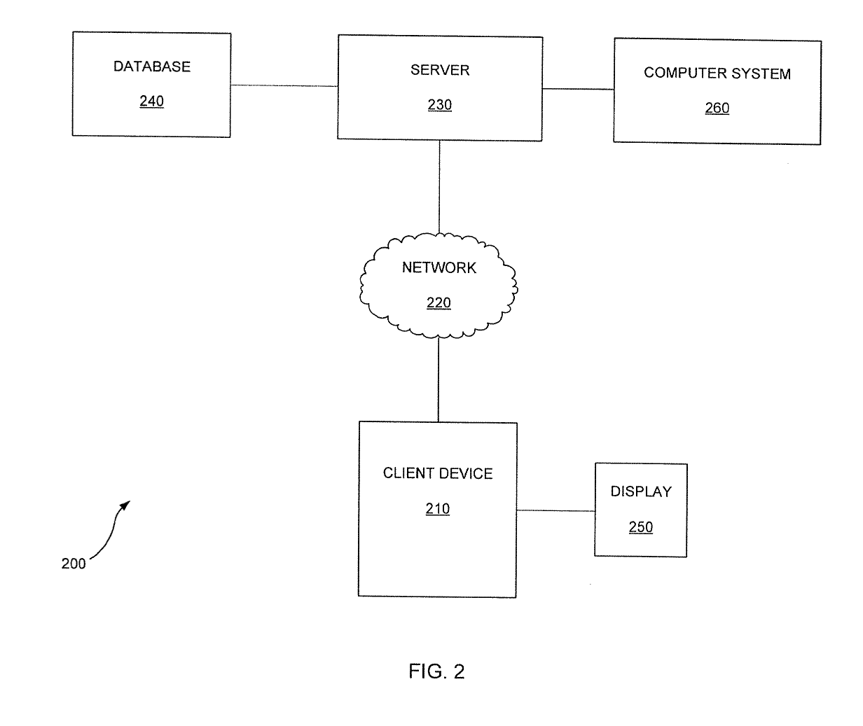

Referring now to FIG. 2, an embodiment of the present invention can be described in the context of an exemplary computer network system 200 as illustrated. System 200 includes an electronic client device 210, such as a personal computer or workstation, that is linked via a communication medium, such as a network 220 (e.g., the Internet), to an electronic device or system, such as a server 230. The server 230 may further be coupled, or otherwise have access, to a database 240 and a computer system 260. Although the embodiment illustrated in FIG. 2 includes one server 230 coupled to one client device 210 via the network 220, it should be recognized that embodiments of the invention may be implemented using one or more such client devices coupled to one or more such servers.

In an embodiment, each of the client device 210 and server 230 may include all or fewer than all of the features associated with the computer 110 illustrated in and discussed with reference to FIG. 1. Client device 210 includes or is otherwise coupled to a computer screen or display 250. Client device 210 can be used for various purposes including both network- and local-computing processes.

The client device 210 is linked via the network 220 to server 230 so that computer programs, such as, for example, a browser, running on the client device 210 can cooperate in two-way communication with server 230. Server 230 may be coupled to database 240 to retrieve information therefrom and to store information thereto. Database 240 may include a plurality of different tables (not shown) that can be used by server 230 to enable performance of various aspects of embodiments of the invention. Additionally, the server 230 may be coupled to the computer system 260 in a manner allowing the server to delegate certain processing functions to the computer system.

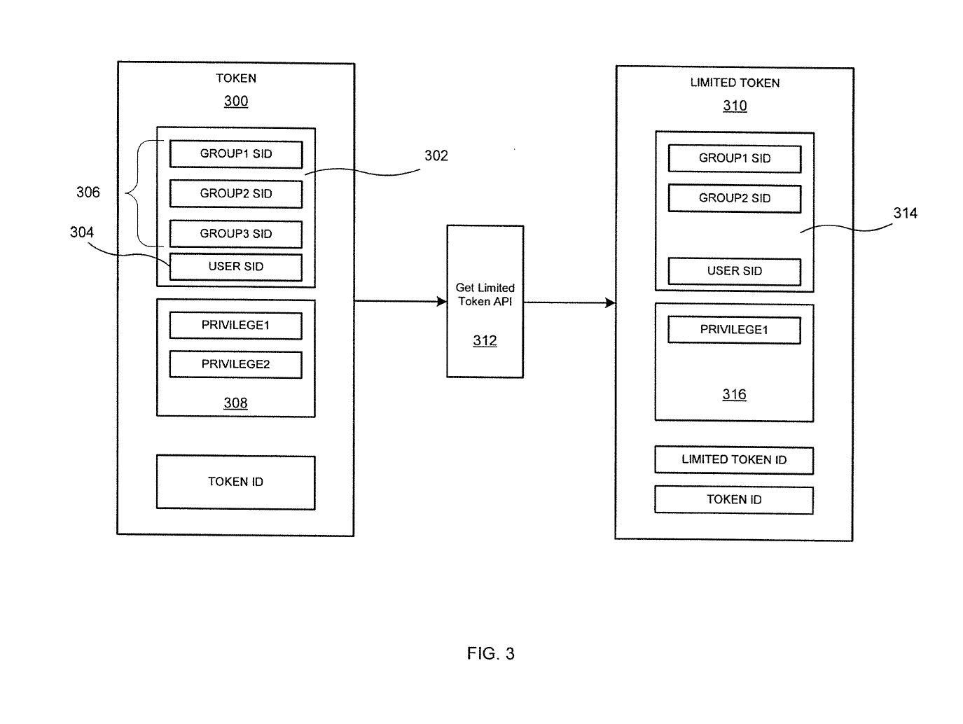

In general, in a conventional operating system, such as, for example, the Windows NT operating system, a user performs tasks by accessing the system's resources via processes (and their threads). When a user logs on to the operating system and is authenticated, a security context may be set up for that user, which includes building an access token 300. As shown in the left portion of FIG. 3, a conventional user-based access token 300 includes a UserAndGroups field 302 including a security identifier (Security ID, or SID) 304 based on the user's credentials and one or more group IDs 306 identifying groups (e.g., within an organization) to which that user belongs and a Token ID. The token 300 also includes a privileges field 308 listing any privileges assigned to the user. For example, one such privilege may give an administrative-level user the ability to set the system clock through a particular application programming interface (API).

The role and functionality of access tokens, such as token 300, in regulating access to system resources are described in detail in, for example, U.S. Pat. No. 6,308,274 entitled “Least Privilege Via Restricted Tokens” to Swift, which is hereby fully incorporated by reference herein.

An embodiment of the invention seeks to create a token that limits access to system resources in proportion to a particular user's group membership and/or granted privileges, for example. Such a limited token may only receive the allowable attributes of a corresponding parent token while omitting selected attributes, such as, for example, membership in the Administrator's group. In order to include the attributes of an existing parent token, an embodiment employs a function that can extract from the parent token certain attributes. The attributes of interest may include, for example:
TOKEN_STATISTICS
TOKEN_OWNER
TOKEN_GROUPS
TOKEN_PRIVILEGES
TOKEN_PRIMARY_GROUP
TOKEN_DEFAULT_DACL
TOKEN_SOURCE

Referring again to FIG. 3, a limited token 310, based on a parent token, such as token 300, may be created by employing a GetLimitedToken API 312 or other executable function. In the example illustrated in FIG. 3, the limited token 310 includes a UserAndGroups field 314, a privileges field 316, a Limited Token ID and the Token ID of the parent token 300. However, for purposes of the application with which the limited token 310 is associated, the limited token has been created with the omission of the Group3 SID and Privilege2 present in the parent token 300. In an embodiment, the limited token 310 provides a user access to fewer system resources than would be the case with the parent token 300. Alternatively, depending on operating system and/or application configuration, the limited token 310 provides a user access to a greater amount of system resources than would be the case with the parent token 300.

A result of this process may be the creation of a clone of an original token with only select attributes present in the clone. This process provides the benefit of creating a clone with the original User ID (SID) and/or group memberships and/or privileges except those deemed to be unsafe in a limited security context.

In some operating systems employing a security mechanism in which embodiments of the present invention may be implemented, the parent token may, in some instances, be created in such manner that the token has membership in a group, such as the Administrator's group, but that membership may be marked as “Deny Only.” Because a security issue may be created if any group in the parent token that was marked as “Deny Only” is omitted in the limited token, the API 312, in embodiments thereof, may fail creation of the limited token or may include the “Deny Only” group or other access-restricting attribute in the limited token.

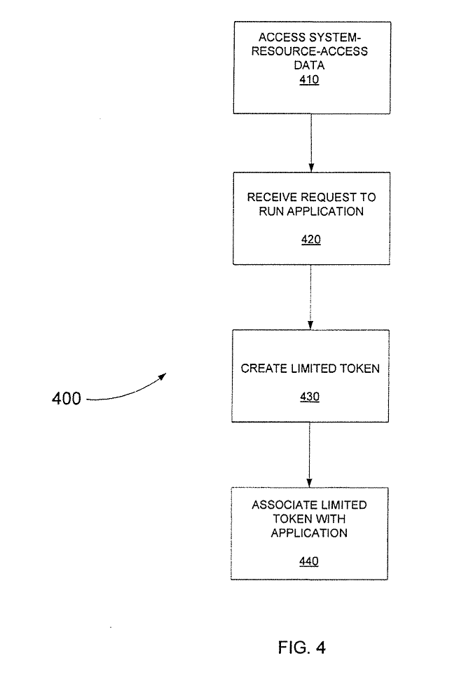

FIG. 4 illustrates a process 400, according to an embodiment of the invention, that can be implemented in a system having a security mechanism that determines access to system resources based on information in an access token against security information associated with each of the resources in order to control access of an application to the system resources. The process 400 is illustrated as a set of operations shown as discrete blocks. The process 400 may be implemented in any suitable hardware, software, firmware, or combination thereof. As such the process 400 may be implemented in computer-executable instructions that can be transferred from one computer, such as server 230, to a second computer, such as client device 210, via a communications medium, such as network 220. The order in which the operations are described is not to be necessarily construed as a limitation.

At a block 410, data related to access by the application to at least one of the system resources is accessed. For example, the API 312 may have access to a set of stored data defining resource-access restrictions to be placed on certain users when utilizing certain applications. This stored data may include, for example, a whitelist of allowable privileges and/or group identifiers.

At a block 420, a request to run the application is received.

At a block 430, a first access token is created having a first set of attributes enabling access to at least one of the system resources and selected based on the data. Alternatively, the attributes may disable access to any of the system resources. These attributes may include, for example, a privilege and/or a group identifier. For example, in an embodiment, the API 312 may employ the GetModifiedTokenGroups and/or GetLimitedPrivileges functions described in at least one application incorporated by reference herein to effect limitation on, for example, the Group SIDs and/or Privileges conferred on the limited token 310. The first token can be based on a second access token having a second set of the attributes. For example, as discussed above, the limited token 310 may be based on the parent token 300. Additionally, the first-set attributes can be fewer in number than the second-set attributes. In an embodiment, the first token, with respect to the second token, provides access to fewer of the system resources. Alternatively, the first token, with respect to the second token, provides access to a greater number or amount of the system resources. Alternatively, the first token, with respect to the second token, provides access to an equal number or amount of the system resources, but, perhaps, different one(s) of the resources.

At a block 440, the first token is associated with the application. Accordingly, the application may run subject to the first token.

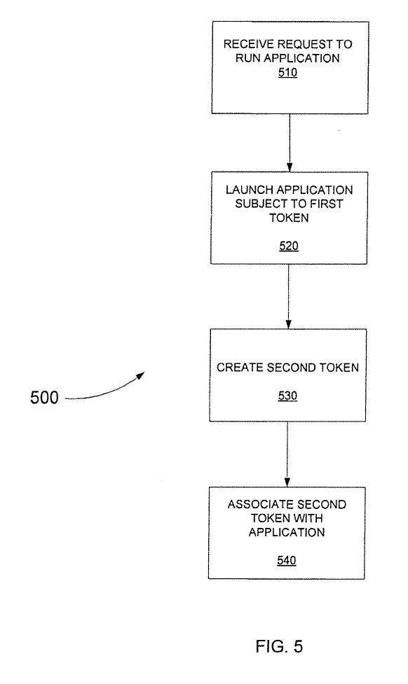

FIG. 5 illustrates a process 500, according to an embodiment of the invention, that can be implemented in a system having a security mechanism that determines access to system resources based on information in an access token against security information associated with each of the resources in order to control access of an application to the system resources. The process 500 is illustrated as a set of operations shown as discrete blocks. The process 500 may be implemented in any suitable hardware, software, firmware, or combination thereof. As such the process 500 may be implemented in computer-executable instructions that can be transferred from one computer, such as server 230, to a second computer, such as client device 210, via a communications medium, such as network 220. The order in which the operations are described is not to be necessarily construed as a limitation.

At a block 510, a request to run the application is received.

At a block 520, the application is launched subject to a first access token providing access to a first set of the system resources. For example, the application may launch subject to its original, unmodified token.

At a block 530, a second access token is created providing access to a second set of the system resources different from the first set. For example, in an embodiment, the API 312 may employ the GetModifiedTokenGroups and/or GetLimitedPrivileges functions described in at least one application incorporated by reference herein to effect limitation on, for example, the Group SIDs and/or Privileges conferred on the limited token 310. The second access token can be based on the first access token. For example, as discussed above, the limited token 310 may be based on the parent token 300.

At a block 540, the second access token is associated with the application. The application runs subject to the second access token without re-launching the application. As such, the process token may be replaced live on the application, granting the application a new security context. In an embodiment, the first token, with respect to the second token, provides access to fewer of the system resources. Alternatively, the first token, with respect to the second token, provides access to a greater number or amount of the system resources. Alternatively, the first token, with respect to the second token, provides access to an equal number or amount of the system resources, but, perhaps, different one(s) of the resources.

In an embodiment, a duplicate of the first access token may be created and stored in memory. As such, if the original security context is subsequently desired, the duplicate may be retrieved and associated with the application, also without re-launching the application. Alternatively, of course, the first access token itself may be stored and subsequently retrieved for similar purposes.

Consequently, a process that is already running with certain attributes, such as membership in the Administrator's group, can be limited (i.e., placed in a more restrictive security context) on the fly without stopping or restarting the application. Additionally, a process that is already running under a particular user's security account can be changed, on the fly, to run under another user's security account without stopping or restarting the application. In addition, a process that was originally launched in a limited security context (i.e., lacking membership in the Administrator's group) can be “promoted” or “escalated” by granting it Administrator's powers without stopping or restarting the application. Since the original process token may be cached (i.e., saved), the process can be reverted or restored to its original security context by replacing the modified token with the original token that was used to launch the application.

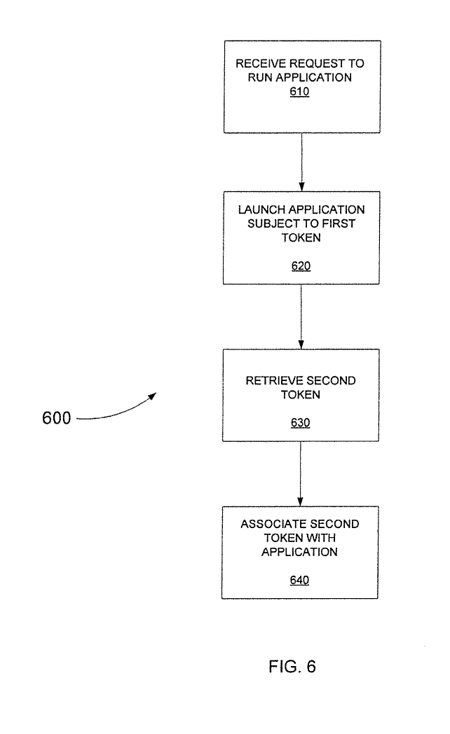

FIG. 6 illustrates a process 600, according to an embodiment of the invention, that can be implemented in a system having a security mechanism that determines access to system resources based on information in an access token against security information associated with each of the resources in order to control access of an application to the system resources. The process 600 is illustrated as a set of operations shown as discrete blocks. The process 600 may be implemented in any suitable hardware, software, firmware, or combination thereof. As such the process 600 may be implemented in computer-executable instructions that can be transferred from one computer, such as server 230, to a second computer, such as client device 210, via a communications medium, such as network 220. The order in which the operations are described is not to be necessarily construed as a limitation.

At a block 610, a request to run the application is received.

At a block 620, the application is launched subject to a first access token providing access to a first set of the system resources.

At a block 630, a second access token is retrieved from a memory and provides access to a second set of the system resources different from the first set. For example, as discussed above with reference to FIG. 5, the original token with which the application was associated when launched may have been previously stored and is thus available for retrieval. The first access token can be based on the second access token.

At a block 640, the second access token is associated with the application. The application runs subject to the second access token without re-launching the application. As such, the process token may be replaced live on the application, granting the application a new security context, which may result in the application running subject to its original, unmodified token. In an embodiment, the first token, with respect to the second token, provides access to fewer of the system resources. Alternatively, the first token, with respect to the second token, provides access to a greater number or amount of the system resources. Alternatively, the first token, with respect to the second token, provides access to an equal number or amount of the system resources, but, perhaps, different one(s) of the resources.

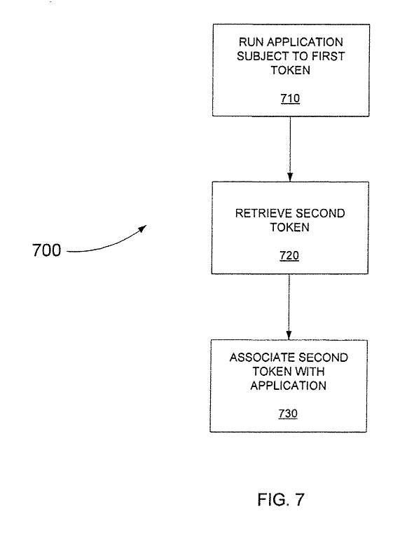

FIG. 7 illustrates a process 700, according to an embodiment of the invention, that can be implemented in a system having a security mechanism that determines access to system resources based on information in an access token against security information associated with each of the resources in order to control access of an application to the system resources. The process 700 is illustrated as a set of operations shown as discrete blocks. The process 700 may be implemented in any suitable hardware, software, firmware, or combination thereof. As such the process 700 may be implemented in computer-executable instructions that can be transferred from one computer, such as server 230, to a second computer, such as client device 210, via a communications medium, such as network 220. The order in which the operations are described is not to be necessarily construed as a limitation.

At a block 710, the application is run subject to a first access token providing access to a first set of the system resources.

At a block 720, a second access token is retrieved from a memory and provides access to a second set of the system resources different from the first set. For example, as discussed above with reference to FIG. 5, the original token with which the application was associated when launched may have been previously stored and is thus available for retrieval. The first access token can be based on the second access token.

At a block 730, the second access token is associated with the application. The application runs subject to the second access token without re-launching the application. As such, the process token may be replaced live on the application, granting the application a new security context, which may result in the application running subject to its original, unmodified token. In an embodiment, the first token, with respect to the second token, provides access to fewer of the system resources. Alternatively, the first token, with respect to the second token, provides access to a greater number or amount of the system resources. Alternatively, the first token, with respect to the second token, provides access to an equal number or amount of the system resources, but, perhaps, different one(s) of the resources.

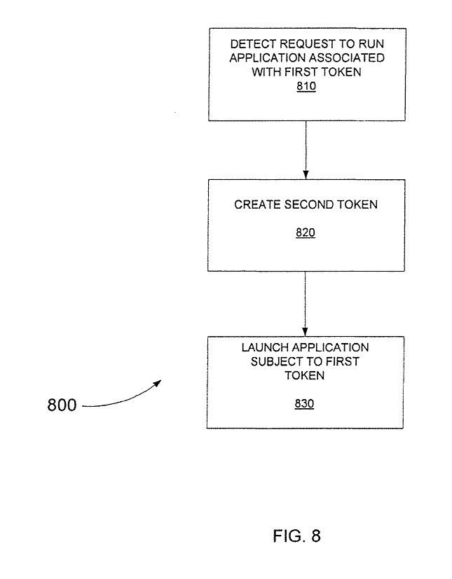

FIG. 8 illustrates a process 800, according to an embodiment of the invention, that can be implemented in a system having a security mechanism that determines access to system resources based on information in an access token against security information associated with each of the resources in order to control access of an application to the system resources. The process 800 is illustrated as a set of operations shown as discrete blocks. The process 800 may be implemented in any suitable hardware, software, firmware, or combination thereof. As such the process 800 may be implemented in computer-executable instructions that can be transferred from one computer, such as server 230, to a second computer, such as client device 210, via a communications medium, such as network 220. The order in which the operations are described is not to be necessarily construed as a limitation.

At a block 810, a request to run the application is detected. The application may be associated with a first access token providing access to a first set of the system resources. For example, in an embodiment, at least a portion of the computer-executable instructions may include a driver operable to monitor process-creation events, such as a request to run an application.

At a block 820, a second access token is created providing access to a second set of the system resources different from the first set. In an embodiment, the second access token is created prior to launching and running the application and in a manner similar to that described elsewhere herein. The second access token can be based on the first access token.

At a block 830, after the second access token is created, the application is launched subject to the second access token. Advantageously, at least one thread of execution of the application runs subject to the second access token. In an embodiment, at least a portion of the computer-executable instructions may include a callback function registered by the driver to facilitate creation and implementation of the second access token. In an embodiment, the first token, with respect to the second token, provides access to fewer of the system resources. Alternatively, the first token, with respect to the second token, provides access to a greater number or amount of the system resources. Alternatively, the first token, with respect to the second token, provides access to an equal number or amount of the system resources, but, perhaps, different one(s) of the resources.

In an embodiment, a duplicate of the first access token may be created and stored in memory. As such, if the original security context is subsequently desired for the application and/or associated threads, the duplicate may be retrieved and associated with the application without re-launching the application. Alternatively, of course, the first access token itself may be stored and subsequently retrieved for similar purposes.

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A method of transferring a computer program product from at least one first computer to at least one second computer connected to the at least one first computer through a communication medium, the method comprising the steps of:
(a) accessing, on the at least one first computer, computer-executable instructions that, when executed in a system having a security mechanism that determines access to system resources based on information in an access token against security information associated with each of the resources, perform at least the steps of:
(1) accessing data related to access by an application to at least one of the system resources;
(2) receiving a request to run the application;
(3) creating a first access token having a first set of attributes enabling access to at least one of the system resources and selected based on the data, the first token being based on a second access token having a second set of the attributes, wherein the first-set attributes are fewer in number than the second-set attributes; and
(4) associating the first token with the application; and
(b) transferring the computer-executable instructions from the at least one first computer to the at least one second computer through the communications medium.

2. The method of claim 1 wherein the first token, with respect to the second token, provides access to fewer of the system resources.

3. The method of claim 1 wherein at least one of the attributes comprises a privilege.

4. The method of claim 1 wherein at least one of the attributes comprises a group identifier.

5. The method of claim 1 wherein the data comprises a list of at least one of the attributes.

6. The method of claim 1 wherein the first-set attributes comprise at least one access-restricting attribute.

7. A computer-readable medium having computer-executable instructions that, when executed in a system having a security mechanism that determines access to system resources based on information in an access token against security information associated with each of the resources, perform at least the steps of:
receiving a request to run an application;
launching the application subject to a first access token providing access to a first set of the system resources;
creating a second access token providing access to a second set of the system resources different from the first set; and
associating the second access token with the application, wherein the application runs subject to the second access token without re-launching the application.

8. The medium of claim 7, wherein the instructions further perform the step of creating a duplicate of the first access token.

9. The medium of claim 8, wherein the instructions further perform the step of storing the duplicate.

10. The medium of claim 7, wherein the instructions further perform the step of storing the first access token.

11. The medium of claim 10, wherein the instructions further perform the step of:
after associating the second access token with the application, associating the first access token with the application, wherein the application runs subject to the first access token without re-launching the application.

12. The medium of claim 7 wherein the second access token is based on the first access token.

13. The medium of claim 7 wherein the second token, with respect to the first token, provides access to fewer of the system resources.

14. A computer-readable medium having computer-executable instructions that, when executed in a system having a security mechanism that determines access to system resources based on information in an access token against security information associated with each of the resources, perform at least the steps of:
receiving a request to run an application;
launching the application subject to a first access token providing access to a first set of the system resources;
retrieving from a memory a second access token providing access to a second set of the system resources different from the first set; and
associating the second access token with the application, wherein the application runs subject to the second access token without re-launching the application.

15. A computer-readable medium having computer-executable instructions that, when executed in a system having a security mechanism that determines access to system resources based on information in an access token against security information associated with each of the resources, perform at least the steps of:
running an application subject to a first access token providing access to a first set of the system resources;
retrieving from a memory a second access token providing access to a second set of the system resources different from the first set; and
associating the second access token with the application, wherein the application runs subject to the second access token without re-launching the application.

16. A computer-readable medium having computer-executable instructions that, when executed in a system having a security mechanism that determines access to system resources based on information in an access token against security information associated with each of the resources, perform at least the steps of:
detecting a request to run an application associated with a first access token providing access to a first set of the system resources;
creating a second access token providing access to a second set of the system resources different from the first set; and
after creating the second access token, launching the application subject to the second access token, wherein at least one thread of execution of the application runs subject to the second access token.

17. The medium of claim 16, wherein the instructions further perform the step of storing the first access token.

18. The medium of claim 17, wherein the instructions further perform the step of:
after associating the second access token with the application, associating the first access token with the application, wherein at least one thread of execution of the application runs subject to the first access token without re-launching the application.
